(19) United States
(12) Patent Application Publication
(10) Pub. No.: US 2018/0319712 A1
(43) Pub. Date: Nov. 8, 2018

(54) QUICK-DRYING TWO-COMPONENT COATING MASS AND METHOD FOR THE PRODUCTION OF SAME

(71) Applicant: BASF SE, Ludwigshafen am Rhein (DE)

(72) Inventor: Klaus SEIP, Mutterstadt (DE)

(73) Assignee: BASF SE, Ludwigshafen am Rhein (DE)

(21) Appl. No.: 15/772,559

(22) PCT Filed: Oct. 31, 2016
(86) PCT No.: PCT/EP2016/076234

§ 371 Date: May 1, 2018

(30) Foreign Application Priority Data
Nov. 2, 2015 (EP) 15192588.0

(51) Int. Cl. C04B 40/06; C04B 28/04; C04B 28/06; C04B 22/16; C04B 22/14; C04B 22/06; C04B 14/28; C04B 14/06; C04B 40/00

(52) U.S. Cl. CPC C04B 40/065; C04B 28/04; C04B 28/06; C04B 22/165; C04B 2103/22; C04B 22/062; C04B 14/28; C04B 14/06; C04B 40/0046; C04B 22/147

(57) ABSTRACT

The present invention relates to a process for producing an aqueous coating composition on the basis of a fast-curing hydraulic binder, the coating composition being applied in liquid form to a substrate, and also to the corresponding coating composition. The coating composition additionally comprises an organic polymeric binder, a retardant, and a curing accelerator. Following prior activation, the coating compositions produce coatings having improved through-drying properties.

The invention relates to a quick-drying aqueous coating composition and also to a process for producing it.

Quick-drying coating compositions are used across a wide application range. Applied in liquid or paste form, they are used, for example, for the production of sealing systems, such as sealing in a composite with tiles, sealing of containers for liquids, construction seals around the building shell (roof, balconies, patios, basements), infrastructure buildings such as bridges, water supply and water treatment plants, and also tunnel constructions. Sealing membranes of this kind are known from the prior art, in the form, for example, of two-pack (powder component+dispersion component) or one-pack (powder) mineral sealing slurries. There are also pastelike, dispersion-bound, and reactive sealing systems. The systems are intended on the one hand to afford adequate protection against the penetration of liquids into the substrate, and on the other hand to ensure a crack-bridging function. In the composite sealing segment, decoupling from the substrate is a further function.

Mineral sealing slurries have a relatively high cement content and polymer content and are therefore unsatisfactory in their crack-bridging properties and in their shrinkage characteristics. Particularly in the case of relatively thick layers, the tendency of such systems to crack is pronounced, and leads to the use of reinforcing fabrics in the region of critical building geometries (e.g., in corners or edges). Particularly in the case of the high-flexibility cementitious sealing slurries, the degree of hydration is limited, and may lead subsequently to posthydration and late-onset embrittlement of the sealing layer.

In comparison to mineral systems, pastelike systems produce seals having significantly better flexibility, but have limitations in terms of through-drying, particularly under critical ambient conditions such as high atmospheric humidity and low temperature. The freeze/thaw stability of the pastelike systems is limited as well, and so they are used only in the interior segment.

In the composite sealing segment, after drying, reactive systems such as PU or epoxy systems show problems of adhesive integration with the covering systems (tiles, for example). These systems, moreover, are in some cases skin-sensitizing, and possibly even toxic.

In the area of mineral sealing slurries, alongside the OPC cements (OPC: ordinary Portland cement), there is nowadays also use of rapid-setting cements (HAC, CSA, etc.) and of calcium sulfate binders. US 2010/015589, for instance, describes a two-component system, with one component comprising, in a pastelike aqueous phase, a passivated aluminate cement, boric acid, and a plasticizer, and the other component comprising an initiator in aqueous phase. The initiator (accelerator) is a mixture of lithium hydroxide and lithium sulfate or lithium carbonate. This system cures in less than 5 minutes to produce within 15 minutes a concrete having a compressive strength of 10-15 MPa. It is, however, necessary for the initiator to be incorporated homogeneously into the pastelike composition, involving considerable mixing work. EP 2 607 330 A1 describes a render composition which is applied to an insulating element. The composition comprises a pastelike first part and a second part, which requires mixing with the first part prior to application. The first part comprises mineral binders, such as calcium aluminate cement, organic binders, such as polymer dispersions or silicone resin dispersions, and an acidic retardant, such as boric acid. The second part comprises an accelerator in aqueous phase, such as lithium hydroxide, lithium carbonate, or lithium sulfate. WO 2014/180859 describes a mineral hydraulic binder based on a calcium sulfoaluminate clinker, which comprises an activator for the hydraulic reaction of the calcium sulfoaluminate, a zinc ion-releasing zinc component, and a setting retardant. US 2014/0343194 describes stabilized aqueous rapid-setting cement suspensions with long shelf life. They comprise a phosphorus-containing compound, such as phosphoric acid, in order to passivate the rapid-setting cement. The cement is reactivated with an accelerator, such as lithium sulfate, lithium carbonate, lithium chloride, or lithium fluoride.

The aim in these cases is to formulate quick-hardening systems which exhibit substantially faster through-curing of the coatings even under adverse conditions, such as high atmospheric humidity and low temperatures. As well as the use of the rapid-setting cements and calcium sulfate binders, there are also other pozzolanic materials employed, such as slag, slag sands, microsilica, and flyash. This improves the CO₂ balance of the systems relative to the Portland cements with high clinker fraction. Shrinkage as well is reduced through the use of rapid-setting cements—see U.S. Pat. No. 4,746,365.

It is an object of the present invention to avoid the disadvantages in the prior art and to provide coating compositions which are easy to produce, which can be processed to form seals with acceptable crack-bridging properties, and which dry rapidly and completely even under high atmospheric humidity and/or low temperature.

This object is achieved by means of a process for producing an aqueous coating composition for application to a substrate, said process comprising the following steps in the specified order:
A) provision of an aqueous pastelike first component (a) by:
   (a1) mixing of at least one fast-curing hydraulic binder and
   (a2) at least one retardant selected from boric acid, orthophosphoric acid, metaphosphoric acid, phosphonic acid (phosphorous acid), an organic phosphonic acid derivative, tartaric acid, and citric acid, and mixtures thereof,
   (a3) addition of a curing accelerator selected from lithium sulfate, lithium acetate, or a mixture thereof to the mixture from (a1) and (a2),
   (a4) addition of at least one organic polymeric binder to the mixture from (a1) to (a3), and
B) addition of a second component (b) comprising at least one activator.

The pastelike first component comprises a fast-curing hydraulic binder (a1). This binder comprises, in particular, aluminate cements, preferably calcium aluminate cement, calcium sulfoaluminate cement, or a mixture thereof. In addition to the aluminate cement, the fast-curing hydraulic binder may also comprise other pozzolanic materials such as Portland cement, slag, slag sands, microsilica, and flyash. This improves the CO2 balance of the systems, relative to the Portland cements with high clinker fraction. The amount of further pozzolanic materials must be calculated so as not to detract significantly from the properties of the binder. The amount in general is in the range from 0.1 to 20 wt %, based on the weight of the fast-curing hydraulic binder.

In a first step the fast-curing hydraulic binder is mixed with a retardant (a2). The retardant (a2) is used for passivating the fast-curing hydraulic binder (a1), in order to prevent its premature setting. Suitable retardants are acidic compounds, particularly boric acid, orthophosphoric acid, metaphosphoric acid, phosphonic acid (phosphorous acid), organic phosphonic acid derivatives, tartaric acid, or citric acid. Other suitable retardants are derivatives of the aforementioned acids that form these acids in an aqueous medium. Examples of such are phosphorus pentoxide, phosphorus trioxide, pyrophosphoric acid, or tripolyphosphoric acid. Examples of suitable phosphonic acid derivatives are aminotrimethylenephosphonic acid, aminoethylphosphonic acid, 1-hydroxyethylidene-1,1-diphosphonic acid, tetramethylenediaminetetramethylenephosphonic acid, hexamethylenediaminetetramethylenephosphonic acid, diethylenetriamine-pentamethylenephosphonic acid, phosphonobutanetricarboxylic acid, N-(phosphonomethyl)iminodiacetic acid, 2-carboxyethylphosphonic acid, or 2-hydroxyphosphonocarboxylic acid. Preferred retardants are boric acid and orthophosphoric acid.

In one embodiment an aqueous solution of the retardant is introduced initially, and the fast-curing hydraulic binder is introduced into the aqueous solution, judiciously with stirring.

Introduced then into the suspension comprising the fast-curing hydraulic binder and the retardant is at least one curing accelerator (a3), which is selected from lithium sulfate, lithium acetate, or a mixture thereof, and the accelerator is mixed with the suspension. Besides lithium sulfate, lithium acetate, or a mixture thereof, the curing accelerator may also comprise further curing accelerators in an amount of up to 50 wt %, based on the total weight of the curing accelerator.

Lithium sulfate and lithium acetate are known curing accelerators. It was therefore surprising that lithium sulfate and lithium acetate can be comprised in the pastelike first component, without the fast-curing hydraulic binder setting prematurely.

At least one organic polymeric binder (a4) is then introduced and admixed into the resulting mixture of components (a1), (a2) and (a3).

The organic binder (a4) is a natural or synthetic polymer or copolymer constructed from monomers such as (meth)acrylic esters, styrene, (meth)acrylic acid, acrylamide, acrylonitrile, carboxylated styrene, butadiene, vinyl acetate, ethylene, or propylene. Examples of suitable polymers are straight acrylics, based more particularly on n-butyl acrylate or 2-ethylhexyl acrylate or copolymers thereof, styrene-acrylate copolymers, styrene-butadiene copolymers, carboxylated styrene-butadiene copolymers, vinyl acetate polymers, ethylene-vinyl acetate copolymers, preferably copolymers based on n-butyl acrylate, acrylonitrile, and methacrylic acid.

The pastelike first component is generally in hydrous form and in addition to constituents (a1) to (a4) may also comprise additives such as rheology additives, thickeners, for example, wetting agents, defoamers, biocides and/or preservatives as component (a5).

The pastelike first component preferably comprises, based in each case on the total weight of the pastelike first component, with the amounts adding up to 100 wt %:

component (a1): 5 to 30 wt %, more particularly 5 to 25 wt %;
component (a2): 0.1 to 8 wt %, more particularly 0.5 to 5 wt %;
component (a3): 0.5 to 5 wt %, more particularly 0.5 to 4 wt % or 0.8 to 4 wt %;
component (a4): 5 to 60 wt %, more particularly 30 to 50 wt %;
component (a5): 0 to 5 wt %, more particularly 0.5 to 4 wt %;
water: 10 to 60 wt %, more particularly 10 to 45 wt %, preferably 10-38 wt %.

The amount of the components including water is selected so as to give a pastelike mixture, meaning that the pastelike first component generally has a viscosity in the range from 1000 mPas to 20000 mPas, determined using a Brookfield DVII plus, spindle 7, 10 rpm. Desirable in particular is a pastelike first component having a water content of less than 45 wt %, preferably having a water content of less than 38 wt %.

The weight ratio of component (a4) to component (a1) is generally in the range from 1:1 to 1:0.08, preferably 1:0.1 to 1:0.4.

The pastelike first component is prepared by mixing the components using customary mixing technologies and mixing apparatus. Component (a4) here may be employed in the form of an aqueous polymer emulsion, comprising generally 30 to 80 wt %, more particularly 50-70 wt %, of polymer, based on the total amount of the polymer emulsion. Alternatively component (a4) may be used in the form of a polymer powder. Components (a2) and (a3) as well may be employed in the form of an aqueous solution (e.g., phosphoric acid in the form of an 83-90% strength aqueous solution) or in powder form.

Additives (a5) and water are judiciously added to the mixture of components (a1) and (a2) or (a1), (a2) and (a3) (judiciously in the following order: defoamers, wetting agents, water, biocides). Lastly component (a4) is introduced. In this way a storage-stable and agglomerate-free pastelike first component is obtained.

Prior to application of the coating composition of the invention, there is generally also addition of mineral fillers, such as silica sand, carbonates, microsilica, or a mixture of two or more thereof, as component (a6). In that case, based in each case on the total weight of the pastelike first component, the pastelike first component has the following constitution:

component (a1): 1 to 28.5 wt %, more particularly 1.5 to 22.5 wt %;
component (a2): 0.02 to 7.6 wt %, more particularly 0.15 to 4.5 wt %;
component (a3): 0.1 to 4.75 wt %, more particularly 0.24 to 3.6 wt %;
component (a4): 1 to 57 wt %, more particularly 9 to 45 wt %;
component (a5): 0 to 4.75 wt %, more particularly 0.15 to 3.6 wt %;
component (a6): 5 to 80 wt %, more particularly 10 to 70 wt %;
water 2 to 57 wt %, more particularly 3 to 40.5 wt %, preferably 3-34.2 wt %.

The second component (b) comprises an activator, which more particularly is an alkalifying agent (pH trigger). Examples of agents contemplated for this purpose include alkali metal and alkaline earth metal hydroxides, oxides, and carbonates, or Portland cement, or mixtures thereof. Preferred are alkali metal hydroxides such as sodium hydroxide, potassium hydroxide, and lithium hydroxide, or mixtures thereof. Particularly preferred are sodium hydroxide or potassium hydroxide or a mixture thereof. The alkalifying agents may be used in the form of an aqueous solution, such as a 10% to 30% strength solution, for example, or in solid form.

The purpose of the second component is to activate the curing and drying. It is therefore not mixed with the pastelike first component until immediately before the application of the coating composition. “Immediately” is to be understood here as less than 10 min. before the application. The amount of alkalifying agent is selected such that the pH rises to at least 10, more particularly at least 12. Since the curing accelerator may already be comprised in the pastelike first component, the preparation and application of the coating composition of the invention is particularly easy, and the pastelike first component can be held at the site of processing of the coating composition. The processing or working time can be adjusted within a wide range via the amount of alkalifying agent and the resultant pH.

For use, the coating composition of the invention is applied in liquid form, in one or more layers, to a substrate, such as to a construction substrate, for example, in a customary way, such as with a roller or a spreader, for example. Examples of suitable substrates are concrete, stone, brick, plaster, plasterboard, wood, glass, aluminum, plastic, or bitumen.

The invention also provides an aqueous composition comprising a pastelike component (a) and also an aqueous coating composition for application to a substrate, said composition being present in two parts (I) and (II), part (I) comprising a pastelike first component (a) and part (II) comprising a component (b) comprising an activator, the pastelike first component comprising:
a1) at least one fast-curing hydraulic binder,
a2) at least one retardant selected from boric acid, orthophosphoric acid, metaphosphoric acid, phosphonic acid (phosphorous acid), and an organic phosphonic acid derivative, and
a3) at least one curing accelerator selected from lithium sulfate, lithium acetate, or a mixture thereof, and
a4) at least one organic polymeric binder.

In particular, the pastelike first component is obtainable according to the above-described process.

Components (I) and (II) and their amounts and/or proportions in the composition and in the coating composition are as described above in connection with the process for producing the coating composition.

With the aid of the coating composition of the invention it is possible to unite the advantages of mineral and pastelike systems. For example, the mechanical properties of the coatings obtained, especially the crack-bridging properties, are improved. As a result of the greatly reduced use of cement, and of the use of a fast-curing hydraulic binder, the cracking tendency, late-onset embrittlement, and shrinkage are also greatly reduced, without limiting the tensile adhesive strength of mineral systems. Accordingly, the tensile adhesive strength of a protective layer produced from the coating composition of the invention is ≥0.5 N/mm², preferably ≥1 N/mm². The figure for the static crack bridging (according to the German general construction office test certificate) is ≥0.4 mm, preferably ≥1 mm, more preferably ≥2 mm. The dynamic crack bridging according to EN 14891 (sealing systems beneath the tile) is ≥0.75 mm, preferably ≥1 mm.

Furthermore, the coating composition of the invention exhibits good through-drying results, particularly at high atmospheric humidity (80-100%), and can be produced without major mixing work.

The coating composition of the invention is therefore especially suitable for producing a sealing membrane on a construction substrate. Examples of this are sealing in a composite with tiles, sealing of containers for liquids, construction seals around the building shell (roof, balconies, patios, basements), infrastructure buildings such as bridges, water supply plants and water treatment plants, and also tunnel constructions.

The examples below elucidate the invention without limiting it.

### EXAMPLE 1

Coating compositions having the constitution indicated in table 1 were produced, with the addition first of lithium sulfate and then of the polymer to the suspension comprising passivated rapid-setting cement (containing aluminate cement plus retardant). Lastly, where provided, the sodium hydroxide solution was added.

TABLE 1

| | Trial 1 | Trial 2 | Trial 3 | Trial 4 | Trial 5 |
|---|---|---|---|---|---|
| Suspension of | 90 | 90 | 90 | — | — |
| passivated rapid-setting | | | | | |
| cement (corresponding to | | | | | |
| slurry 2 from | | | | | |
| US 2014/0343194) ¹⁾ | | | | | |
| Portland cement 52.5N | | | | | 188 |
| Polymer²⁾ | 180 | 180 | 180 | 180 | 132.7 |
| Water | 120 | 120 | 120 | 156 | 117 |
| Dispersant | 5 | 5 | 5 | 5 | — |
| Defoamer | 4 | 4 | 4 | 4 | 3.7 |
| Lithium sulfate | 8 | 8 | — | — | — |
| Finely ground limestone | 389 | 389 | 389 | 453 | 75 |
| Fine sand | 200 | 200 | 200 | 200 | 483 |
| Microsilica | 1 | 1 | 1 | 1 | — |
| Cellulose ether | 0.75 | 0.75 | 0.75 | 0.75 | — |
| Thickener | 3 | 3 | 3 | 0.75 | 0.6 |
| Total | 1000 | 1000 | 1000 | 1000 | 1000 |
| pH trigger (20% strength | — | 10 | 10 | | |
| NaOH) | | | | | |

¹⁾ Water 38.115%; phosphoric acid (85% strength) 1.19%; dispersant (sodium polyacrylate) 1%; aluminate cement 59.38%; xanthan gum 0.3%; biocide (isothiazolone) 0.015% (in each case % by weight, based on the total weight of the suspension)
²⁾Copolymer based on n-butyl acrylate, acrylonitrile, and methacrylic acid.

The coating composition constituted as above was mixed up using a laboratory mixer. Of the compositions from trials 1 to 3, in each case 250 g were introduced into a plastic beaker and sealed firmly with a lid, so that no moisture can escape and after a short time an atmospheric humidity over the composition of 100% is established. Trial 1 therefore corresponds to the pastelike first component (a) without activating agent (b). In a second trial, the same composition was activated with sodium hydroxide solution, and placed into a beaker in the same way as in trial 1. Both beakers were stored with closed lid at room temperature (23° C.). At certain time intervals (pot life), the beakers were opened and the viscosity is tested by stirring with a spatula knife. The results are given in table 2.

TABLE 2

| | Composition | Composition | Composition |
|---|---|---|---|
| Pot life | from trial 1 | from trial 2 | from trial 3 |
| After 15 min | no stiffening | tough | no stiffening |
| After 30 min | no stiffening | tough | no stiffening |
| After 60 min | no stiffening | plastic | no stiffening |
| After 1:30 h | no stiffening | hard | no stiffening |
| After 2 h | no stiffening | | no stiffening |
| After 2:30 h | no stiffening | | no stiffening |
| After 3 h | no stiffening | | no stiffening |
| After 3:30 h | no stiffening | | no stiffening |
| After 4 h | no stiffening | | no stiffening |
| After 4:30 h | no stiffening | | no stiffening |
| After 5 h | no stiffening | | no stiffening |
| After 7 h | no stiffening | | no stiffening |
| After 24 h | no stiffening | | hard |

The activated composition from trial 2 is hard after 1:30 h, whereas even after 24 h no curing can be observed in the inactivated composition from trial 1. Likewise, the activated composition from trial 3, which admittedly does not contain a curing accelerator in contrast to the composition from trial 2, is still not hard after 7 h.

### Example 2

Three beakers are prepared with the compositions 1 to 3 from example 1 in the same way and are stored at 5° C. Here again, after appropriate intervals of time, the through-curing of the composition is tested.

| | Composition | Composition | Composition |
|---|---|---|---|
| Pot life | from trial 1 | from trial 2 | from trial 3 |
| After 15 min | no stiffening | no stiffening | no stiffening |
| After 30 min | no stiffening | no stiffening | no stiffening |
| After 60 min | no stiffening | no stiffening | no stiffening |
| After 1:30 h | no stiffening | tough | no stiffening |
| After 2 h | no stiffening | tough | no stiffening |
| After 2:30 h | no stiffening | tough/plastic | no stiffening |
| After 3 h | no stiffening | plastic | no stiffening |
| After 3:30 h | no stiffening | plastic | no stiffening |
| After 4 h | no stiffening | hard | no stiffening |
| After 4:30 h | no stiffening | | no stiffening |
| After 5 h | no stiffening | | no stiffening |
| After 7 h | no stiffening | | no stiffening |
| After 24 h | no stiffening | | no stiffening |

Example 2 shows that while the activated system does react with a delay at low temperatures, in comparison to example 1, it nevertheless still undergoes through-curing. The unactivated system (composition from trial 1) and also the activated but not accelerated system (composition from trial 3) show no reaction within 24 h.

### Example 3

The composition from trial 1, along with 20% strength sodium hydroxide solution and two concrete slabs, were stored in a conditioning cabinet at 7° C. and 95% atmospheric humidity for 24 hours. Thereafter one concrete slab was coated with the composition from trial 1 (plate 1). The application rate in this case was 1.5 kg/m². The second concrete slab was coated in the same way with the activated formulation (composition from trial 1+1% sodium hydroxide solution) (plate 2). After the coating operation, the two concrete slabs were immediately stored again at 7° C. and 95% air humidity in the conditioning cabinet. The time up to the through-curing of the layers was determined (drying time). For this purpose, the coating was contacted with a finger, which was turned by 90 degrees on the surface under gentle pressure. Through-curing is sufficient when no imprints or instances of damage are apparent. In that case the layer has solidified to a point at which it is possible to apply a further, second layer by roller or toothed spreader.

The trials are repeated at different atmospheric humidities; the results are shown in table 3:

TABLE 3

| | Drying time (min) | |
|---|---|---|
| | Plate 1 | Plate 2 |
| Temp.: 7° C. at 80% humidity | | |
| 1st layer | 195 | 125 |
| 2nd layer | 180 | 110 |
| Temp.: 7° C. at 85% humidity | | |
| 1st layer | 230 | 140 |
| 2nd layer | 240 | 130 |
| Temp.: 7° C. at 90% humidity | | |
| 1st layer | 270 | 160 |
| 2nd layer | 255 | 140 |
| Temp.: 7° C. at 95% humidity | | |
| 1st layer | 340 | 300 |
| 2nd layer | 335 | 300 |

The trials show that the new system with activation is particularly effective in the 80-90% atmospheric humidity range and at low temperature.

### Comparison of the Crack Bridging and Tensile Adhesive Strength:

The compositions from trials 1, 4, and 5 in example 1 are subjected to comparative testing of the crack bridging according to DIN EN 14891 and of the tensile adhesive strength according to DIN EN 1348. The results are shown in table 4.

TABLE 4

| | Composition | Composition | Composition |
|---|---|---|---|
| Testing | from trial 1 | from trial 4 | from trial 5 |
| Crack bridging to | 1.49 mm | 2.85 mm | 0.8 mm |
| DIN EN 14891 (application: | | | |
| 3 kg/m²) | | | |
| Tensile adhesive strength to | 1.12N/mm² | 0.76N/mm² | 1.7N/mm² |
| DIN EN 1348 after | | | |
| 28 days' storage at 23° C., | | | |
| 50% rel. humidity | | | |

The results from table 4 show that the new activated system from trial 1, in comparison to a standard cementitious sealing slurry (trial 5), exhibits significantly better crack bridging and, in comparison to the cement-free system from trial 4, a significantly better tensile adhesive strength.

1: A process for producing an aqueous coating composition, the process comprising, in a specified order:
preparing an aqueous paste-like first component by
mixing at least one fast-curing hydraulic binder and at least one retardant selected from the group consisting of boric acid, orthophosphoric acid, metaphosphoric acid, phosphonic acid, phosphorous acid, an organic phosphonic acid derivative, tartaric acid, and citric acid thereby forming a first mixture,
adding at least one curing accelerator selected from the group consisting of lithium sulfate and lithium acetate to the first mixture, thereby forming a second mixture, and
adding at least one organic polymeric binder to the second mixture, and
adding a second component comprising at least one activator.

2: The process according to claim 1,
wherein the at least one activator is added immediately before applying the aqueous coating composition.

3: The process according to claim 1,
wherein the aqueous paste-like first component further comprising at least one additive.

4: The process according to claim 1,
wherein the aqueous paste-like first component comprises, based in each case on a total weight of the aqueous paste-like first component:
5 to 30 wt % of the at least one fast-curing hydraulic binder;
0.1 to 8 wt % of the at least one retardant;
0.5 to 5 wt % of the at least one curing accelerator;
5 to 60 wt % of the at least one organic polymeric binder;
0 to 5 wt % of at least one additive;
10 to 60 wt % of water;
amounts adding up to 100 wt %.

5: The process according to claim 1,
wherein a weight ratio of the at least one organic polymeric binder to the at least one fast-curing hydraulic binder is from 1:1 to 1:0.08.

6: The process according to claim 1,
wherein the aqueous paste-like first component further comprises mineral fillers.

7: The process according to claim 1,
wherein the aqueous paste-like first component comprises, based in each case on a total weight of the aqueous paste-like first component:
1 to 28.5 wt % of the at least one fast-curing hydraulic binder;
0.02 to 7.6 wt % of the at least one retardant;
0.1 to 4.75 wt % of the at least one curing accelerator;
1 to 57 wt % of the at least one organic polymeric binder;
0 to 4.75 wt % of at least one additive;
5 to 80 wt % of mineral fillers; and
2 to 57 wt % of water.

8: The process according to claim 6,
wherein a fraction of the aqueous paste-like first component is from 90 to 98 wt % and a fraction of the second component is from 2 to 10 wt %, based on a total weight of the aqueous coating composition.

9: The process according to claim 1,
wherein the at least one fast-curing hydraulic binder is at least one selected from the group consisting of calcium aluminate cement and calcium sulfoaluminate cement.

10: The process according to claim 1,
wherein the at least one retardant is phosphoric acid, boric acid or a mixture of the phosphoric acid and the boric acid.

11: The process according to claim 1,
wherein the at least one curing accelerator is lithium sulfate.

12: The process according to claim 1,
wherein the at least one activator is an alkali metal hydroxide.

13: The process according to claim 1,
wherein the aqueous paste-like first component is prepared by first introducing the at least one fast-curing hydraulic binder into an aqueous solution of the at least one retardant and then introducing the the at least one curing accelerator and the at least one organic polymeric binder in succession into a resulting mixture.

14: An aqueous composition, comprising a paste-like component,
wherein the past-like component which comprises:
at least one fast-curing hydraulic binder,
at least one retardant selected from the group consisting of boric acid, orthophosphoric acid, meta-phosphoric acid, phosphonic acid, phosphorous acid, and an organic phosphonic acid derivative,
at least one curing accelerator selected from the group consisting of lithium sulfate and lithium acetate, and
at least one organic polymeric binder.

15: The composition according to claim 14,
wherein the paste-like component is obtainable by a process, comprising, in a specified order:
mixing the at least one fast-curing hydraulic binder and the at least one retardant, thereby forming a first mixture;
adding the at least one curing accelerator to the first mixture, thereby forming a second mixture;
adding the at least one organic polymeric binder to the second mixture; and
adding a second component comprising at least one activator.

16: An aqueous coating composition, which is present in at least two parts (I) and (II),
wherein the part (I) comprises the aqueous composition as defined in claim 14 and
the part (II) comprises a component comprising an activator.

17: A sealing membrane, comprising:
the aqueous composition of claim 14.

18: A process for preparing a sealing membrane comprising:
preparing the aqueous coating composition by the process of claim 1, and
applying the aqueous coating composition to a substrate for curing.

19: A sealing membrane, comprising:
the aqueous coating composition of claim 16.
